(19) United States
(12) Patent Application Publication
(10) Pub. No.: US 2026/0160913 A1
(43) Pub. Date: Jun. 11, 2026

(54) SEISMIC EXPLORATION SYSTEM BASED ON SEAFLOOR CRAWLER

(71) Applicants: First Institute of Oceanography, Ministry of Natural Resources, Qingdao (CN); Qingdao Marine Science and Technology Center, Qingdao (CN)

(72) Inventors: Yanliang PEI, Qingdao (CN); Kai LIU, Qingdao (CN); Xishuang LI, Qingdao (CN); Chenguang LIU, Qingdao (CN); Guangming KAN, Qingdao (CN); Xuefa SHI, Qingdao (CN); Baohua LIU, Qingdao (CN)

(73) Assignees: First Institute of Oceanography, Ministry of Natural Resources, Qingdao (CN); Qingdao Marine Science and Technology Center, Qingdao (CN)

(21) Appl. No.: 19/389,107

(22) Filed: Nov. 14, 2025

(30) Foreign Application Priority Data
Dec. 5, 2024 (CN) 2024117739230

(51) Int. Cl. G01V 1/38; G01V 1/36

(52) U.S. Cl. CPC G01V 1/3808; G01V 1/36; G01V 1/3835; G01V 1/3852

(57) ABSTRACT

The invention provides a seismic exploration system based on a seafloor crawler, belonging to the field of geophysical technology, comprising: a survey vessel, a seafloor crawler, a seismic source, a receiver, a control chip, wherein the survey vessel and the seafloor crawler are connected by a towing rope; the seafloor crawler has a towing cable provided at the rear; the seismic source and receiver are mounted on the towing cable; the seafloor crawler is provided with an electronic cabin, where a data control chip is disposed, which exchanges data with the drive unit of the seafloor crawler, seismic source, and receiver; the control chip is provided with a seismic exploration control module for setting vibration parameters of the seismic source and preprocessing the data collected by the receiver to obtain seismic exploration data; the electronic cabin also contains a data transmission device, which is electrically connected to the control chip.

### CROSS-REFERENCE TO RELATED APPLICATIONS

The application claims priority to Chinese patent application No. 2024117739230, filed on Dec. 5, 2024, the entire contents of which are incorporated herein by reference.

### TECHNICAL FIELD

The present invention belongs to the field of geophysical technology, and specifically relates to a seismic exploration system based on a seafloor crawler.

### BACKGROUND

Seafloor seismic exploration, as an important tool in oil and gas exploration and seafloor structural research, has garnered widespread attention in recent years. By detecting the characteristics of reflection waves in strata, it is possible to analyze subsurface structures, providing important evidence for resource development and geological research. Compared to land-based seismic exploration, seafloor seismic exploration faces a more complex working environment and technical challenges. First, the complex and varied seafloor topography and the varying textures of the seabed lead to significant differences in the propagation characteristics of seismic waves in different media, complicating data processing and interpretation. Second, the underwater environment places higher demands on the operational stability of seismic instruments; at the same time, factors such as water pressure, temperature and the like can also affect instrument performance and data quality. Furthermore, due to the limited deployment of seafloor receiving equipment, uniform coverage cannot be achieved as on land, further reducing data reliability. Commonly used seafloor seismic OBS/OBC detection technology, although located on the seafloor, are difficult to achieve a comprehensive and accurate seismic detection, as the seismic source is located at the sea surface and the generated seismic waves suffer from attenuation and diffusion through deep seawater.

### SUMMARY

In view of the above, the present invention provides a seismic exploration system based on a seafloor crawler, which can address the technical problems of low comprehensiveness and accuracy in existing seafloor seismic exploration methods.

The present invention is achieved as follows:

The present invention provides a seismic detection system based on a seafloor crawler, comprising: a survey vessel, a seafloor crawler, a seismic source, a receiver, and a control chip, wherein the survey vessel and the seafloor crawler are connected by a towing rope; the seafloor crawler has a towing cable provided at the rear; the seismic source and the receiver are mounted on the towing cable; the seafloor crawler is provided with an electronic cabin; the data control chip is disposed within the electronic cabin; the control chip exchanges data with the drive unit of the seafloor crawler, the seismic source, and the receiver; the control chip is provided with a seismic exploration control module for setting the vibration parameters of the seismic source and preprocessing the data collected by the receiver to ultimately obtain seismic exploration data; the electronic cabin also contains a data transmission device, which is electrically connected to the control chip and is used to transmit the seismic exploration data to the survey vessel.

On the basis of the above technical solution, the seismic detection system based on a seafloor crawler of the present invention can also be improved as follows:

Among these, the survey ship is equipped with a satellite navigation system, an underwater positioning system, and a power supply unit.

Further, the seafloor crawler is a tracked seafloor crawler or a multi-legged seafloor crawler.

Further, the seismic source is a controllable seismic source, including any one of a controllable transducer seismic source and a controllable airgun seismic source.

Further, the vibrating surface of the seismic source transmitting array contacts the seafloor sediment, exciting both primary waves (P waves) and secondary waves (S waves), and improving the seismic source output efficiency.

Further, the receiver is a node-type receiver array or a multi-channel seismic cable.

Further, the node-type receiver array includes multiple three-component geophones and multiple hydrophones, wherein the three-component geophones are used to receive vector seismic signals in the X, Y, and Z directions, and the hydrophones are used to receive scalar seismic signals.

Further, the data transmission device transmits the seismic detection data to the survey vessel via a data cable or wireless channel. Further, the seafloor crawler is also provided with a sensor module comprising at least a depth gauge, an altimeter, a gyroscope, and an accelerometer.

Further, the seismic detection control module is used to perform the following steps:
S10, controlling the seafloor crawler to crawl within a predetermined detection area to obtain the seafloor crawler pose information, while controlling the seismic source to intermittently transmit seismic waves and receive reflection waves via the receiver;
S20, calculating an outlier set in the first reflection wave, including amplitude outliers, frequency outliers, and phase outliers, using a sliding window by means of Bayesian outlier detection;
S30, aligning the outlier set with the seismic waves according to the order in which the seismic waves are intermittently transmitted; extracting attributes of the seismic waves using a sliding window, recorded as seismic wave attributes, and calculating the correlation between the seismic wave attributes and the outlier set;
S40, deleting, from the seismic wave attributes, seismic wave attributes with a correlation greater than a preset correlation threshold to obtain remaining features, and calculating, using a preset attribute-parameter equations, seismic wave parameters corresponding to the remaining features as optimization parameters;
S50, controlling the seismic source to emit new seismic waves according to the optimization parameters, and receiving new reflection waves via the receiver; preprocessing the new reflection waves to obtain preprocessed new reflection waves;
S60, subjecting the new seismic wave and the preprocessed new reflection wave to waveform alignment and travel time analysis to calculate the propagation time and velocity of the new seismic wave in different media;
S70, subjecting the preprocessed new reflection wave to normal moveout correction using preset velocity correction equations to eliminate time differences caused by different seismic wave propagation paths;
S80, subjecting the corrected preprocessed new reflection wave to spectrum analysis and amplitude recovery to improve the signal-to-noise ratio and resolution of signals and to obtain results as detection data.

The vibration parameters of the seismic source include frequency, amplitude, and duration.

The preset attribute-parameter equations include a frequency equation, an amplitude equation, and a duration equation.

The steps for setting the correlation threshold specifically include:
1. Collecting historical exploration data, including seismic wave attributes and corresponding outlier set under different geological environments;
2. Using a machine learning algorithm (such as a support vector machine or random forest) to train a classification model, using the seismic wave attributes as input and the presence or absence of outlier set as output;
3. Evaluating the performance of the model, including precision, recall, and F1 score at different correlation thresholds using a cross-validation method;
4. Selecting a correlation threshold that achieves the best balance between precision and recall.

The velocity correction equations include a P-wave velocity correction equation, an S-wave velocity correction equation, a multiple wave correction equation, an NMO correction equation, and a DMO correction equation.

Below are the formulas and explanations for each equation:

### 1. Frequency Equation:

$$f = {f}_{0} + α \cdot log ( d ) + β \cdot T + γ \cdot ρ + {ε}_{f} ;$$

wherein f is optimized seismic source frequency; f₀ is initial frequency; d is detection depth; T is seafloor temperature; ρ is seafloor sediment density; α, β, γ are undetermined coefficients; ε_{f} is error term.

### Parameter Acquisition Method:

d is obtained by direct measurement with a depth gauge; T is obtained by measurement with a temperature sensor; ρ is obtained by estimation through sampling analysis or acoustic logging.

### 2. Amplitude Equation:

$$A = {A}_{0} \cdot {e}^{- λ d} \cdot ( 1 + μ \cdot v + v \cdot a ) + {ε}_{A} ;$$

wherein A is optimized seismic source amplitude; A₀ is initial amplitude; d is detection depth; v is seafloor crawler velocity; a is seafloor crawler acceleration; λ, μ, σ are undetermined coefficients; ε_{A} is error term.

### Parameter Acquisition Method:

v and a are obtained by measurement with the velometer and accelerometer on the seafloor crawler.

### 3. Duration Equation:

$$t = {t}_{0} + ω \cdot sin ( θ ) + ϕ \cdot cos ( ψ ) + χ \cdot H + {ε}_{t} ;$$

wherein t is optimized seismic source duration; t₀ is initial duration; θ is seafloor slope; ψ is the pitch angle of the seafloor crawler; H is seawater depth; ω, φ, χ are undetermined coefficients; εₜ is error term.

### Parameter Acquisition Method:

θ is obtained by seafloor topography measurement; ψ is obtained by gyroscope measurement; H is obtained by depth gauge measurement.

### 4. P-Wave Velocity Correction Equation:

$${V}_{p} = {V}_{p 0} + {k}_{p} \cdot P + {m}_{p} \cdot S + {n}_{p} \cdot \frac{\partial P}{\partial d} + {ε}_{p} ;$$

wherein Vₚ is corrected P wave velocity; Vₚ₀ is initial P wave velocity; P is pore pressure; S is rock saturation;

$$\frac{\partial P}{\partial d}$$

is pressure gradient; kₚ, mₚ, nₚ are undetermined coefficients; εₚ is error term.

### Parameter Acquisition Method:

P is obtained by stress sensor measurement; S ρ is obtained by estimation through resistivity logging;

$$\frac{\partial P}{\partial d}$$

is obtained by calculation through pressure variation with depth.

### 5. S Wave Velocity Correction Equation:

$${V}_{s} = {V}_{s 0} + {k}_{s} \cdot σ + {m}_{s} \cdot ϕ + {n}_{s} \cdot \sqrt{f} + {ε}_{s} ;$$

wherein Vₛ is corrected S wave velocity; Vₛ₀ is initial S wave velocity; σ is effective stress; φ is porosity; f is dominant frequency; kₛ, mₛ, nₛ are undetermined coefficients; εₛ is error term.

### Parameter Acquisition Method:

σ is obtained by stress sensor measurement; φ is obtained by estimation through density logging or neutron logging; f is directly obtained from source parameters.

### 6. Multiple Wave Correction Equation:

$${T}_{m} = {T}_{p} + \frac{2 h}{{V}_{w}} \cdot {( 1 + \frac{{V}_{w}}{{V}_{p}} \cdot {sin}^{2} ( {θ}_{i} ) )}^{1 / 2} + {ε}_{m} ;$$

wherein Tₘ is travel time after multiple correction; Tₚ is original P wave travel time; h is water depth; V_{w} is sound velocity in water; Vₚ is formation P wave velocity; θᵢ is incidence angle; εₘ is error term.

### Parameter Acquisition Method:

h is obtained by depth gauge measurement; V_{w} is obtained by sonic velocity meter; θᵢ is obtained by calculation through ray tracing.

### 7. NMO Correction Equation:

$${T}_{NMO} = \sqrt{{T}_{0}^{2} + \frac{{x}^{2}}{{V}_{R MS}^{2}}} - {T}_{0} + {ε}_{N} ;$$

wherein T_{NMO} is NMO correction time; T₀ is zero-offset travel time; x is offset; V_{RMS} is root mean square velocity; ε_{N} is error term.

### Parameter Acquisition Method:

T₀ is obtained from initially processed seismic records; x is obtained by calculation from the position information of the seafloor crawler; V_{RMS} is obtained by estimation through velocity analysis.

### 8. DMO Correction Equation:

$${T}_{D M O} = {T}_{NMO} - \frac{{x}^{2} \cdot {tan}^{2} ( θ )}{2 \cdot {V}_{i n t}^{2} \cdot {T}_{0}} + {ε}_{D} ;$$

wherein T_{DMO} is DMO correction time; T_{NMO} is NMO correction time; x is offset; θ is reflection point dip angle; Vᵢₙₜ is interlayer velocity; T₀ is zero-offset travel time; ε_{D} is error term.

### Parameter Acquisition Method:

θ is obtained by seismic profile interpretation; Vᵢₙₜ is obtained by is estimation through interlayer velocity analysis.

These equations cover several key steps in the seismic exploration process, including seismic source parameter optimization, velocity correction, and multiple wave suppression. By using these equations, it is possible to significantly improve the accuracy and resolution of seafloor seismic exploration.

The Bayesian outlier detection method is specifically described as follows:

$$P ( A \vert D ) = \frac{P ( D \vert A ) \cdot P ( A )}{P ( D )} ;$$

wherein P(A|D) is posterior probability of outlier occurrence given the observed data D; P(D|A) is likelihood probability of the observed data under abnormal conditions; P(A) is prior probability of outlier occurrence; P(D) is marginal probability of the observed data.

Criteria for determining outliers are as follows:

### 1. Amplitude Outlier:

$$\vert {A}_{i} - {μ}_{A} \vert > {k}_{A} \cdot {σ}_{A} ;$$

wherein Aᵢ is the amplitude of the i^{th} sampling point; μ_{A} is the mean of amplitudes within the sliding window; σ_{A} is the standard deviation of amplitudes within the sliding window; k_{A} is the amplitude outlier determination coefficient, which typically is 2˜3.

### 2. Frequency Outlier:

$$\vert {f}_{i} - {μ}_{f} \vert > {k}_{f} \cdot {σ}_{f} ;$$

wherein fᵢ is the dominant frequency of the ith time window; μ_{f} is the mean of dominant frequencies within the sliding window; σ_{f} is the standard deviation of dominant frequencies within the sliding window; k_{f} is the frequency outlier determination coefficient, which typically is 2˜3.

### 3. Phase Outlier:

$$\vert {ϕ}_{i} - {μ}_{ϕ} \vert > {k}_{ϕ} \cdot {σ}_{ϕ} ;$$

wherein φᵢ is the instantaneous phase of the i^{th} sampling point; μ_{φ} is the mean of instantaneous phases within the sliding window; σ_{φ} is the standard deviation of instantaneous phases within the sliding window; k_{φ} is the phase outlier determination coefficient, which typically is 2˜3.

### Parameter Acquisition Method:

1. Amplitude Aᵢ is obtained directly from the raw data collected by the receiver.

2. Dominant frequency fᵢ is obtained by subjecting each time window to a Fourier transform and then finding the frequency point with the highest energy:

$${f}_{i} = arg {max}_{f} {\vert {F}_{i} ( f ) \vert}^{2} ;$$

wherein Fᵢ(f) is the Fourier transform in the ith time window.

3. Instantaneous phase φᵢ is obtained by calculation using the Hilbert transform:

$${ϕ}_{i} = arctan ( \frac{H [ {x}_{i} ]}{{x}_{i}} ) ;$$

wherein xᵢ is the original signal, H[xᵢ] is the Hilbert transform of xᵢ.

4. Mean μ and standard deviation σ are obtained by calculation using the data within the sliding window:

$$μ = \frac{1}{N} {\sum }_{i = 1}^{N} {x}_{i} ;$$

$$σ = \sqrt{\frac{1}{N - 1} {\sum }_{i = 1}^{N} {( {x}_{i} - μ )}^{2}} ;$$

wherein N is the length of the sliding window, xᵢ represents amplitude, frequency, or phase data.

5. The optimal value for outlier determination coefficient k can be determined by cross-validation; the specific steps are as follows:

a. Selecting a set of candidate k values, for example, [1.5,2.0,2.5,3.0,3.5].

b. Dividing the dataset into a training set and a validation set.

c. Calculating outliers using the training set for each k value, and then evaluating detection performance (e.g., F1 score) on the validation set.

d. Select the k value with the optimal performance on the validation set.

The above method can comprehensively detect anomalies in the reflection wave, including anomalies in amplitude, frequency, and phase. These anomalies may indicate unique changes in the subsurface geological structure or problems in the data acquisition process, which is of great significance for subsequent data processing and geological interpretation.

Among these, the step S10 specifically includes: controlling the seafloor crawler to crawl within a predetermined detection area to obtain real-time pose information of the seafloor crawler, including depth, altitude, heading angle, pitch angle, etc.; meanwhile, controlling the seismic source to intermittently transmit seismic waves using a control chip, and recording the reflected seismic wave signals via a receiver array. This step allows for the obtaining of seafloor topography information and raw seismic reflected wave data, providing the basis for subsequent signal processing and geological interpretation.

Among these, the step S20 specifically includes: subjecting the amplitude, frequency and phase attributes of the received seismic reflection wave signal to statistical analysis using a sliding window; calculating the outlier occurrence probability of each attribute under given observation data using the Bayesian outlier detection method; determining it to be a corresponding outlier when the amplitude, frequency or phase exceeds the mean value within the sliding window plus or minus 2-3 times the standard deviation. This step allows for automatic identification of characteristic points in the original reflected wave that may reflect geological anomalies, providing clues for subsequent processing and analysis.

Among these, the step S30 specifically includes: aligning and pairing each outlier with the corresponding seismic wave reflection signal according to the emission timing of the seismic source; extracting the amplitude, frequency, phase and other attributes of each seismic wave reflection signal using the method of sliding window, and calculating the correlation between these attributes and the outlier set. This step allows for deep exploration of the intrinsic relationship between seismic wave attributes and outliers, providing the basis for subsequent optimization parameter calculations.

Among these, the step S40 specifically includes: setting a reasonable correlation threshold, such as 0.7, eliminating seismic wave attributes with a correlation greater than the threshold to obtain remaining attributes; then, calculating seismic source parameters corresponding to the remaining attributes as optimization parameters using preset attribute-parameter equations, including the frequency equation, amplitude equation, and duration equation. This step allows for the screening of the attributes most relevant to outliers from a large number of seismic wave attributes, and based on these, the optimal seismic source parameters can be calculated, providing the basis for subsequent seismic source optimization.

Among these, the step S50 specifically includes: controlling the seismic source to emit new seismic waves via the control chip using the optimization parameters calculated in step S40; recording new seismic wave reflection signals at the receiver, and then preprocessing these new reflection waves, including denoising, frequency band filtering, waveform correction, etc. to obtain preprocessed new reflection wave data. This step allows for the obtaining of new seismic reflection data of higher quality using the optimized seismic source parameters, providing the basis for subsequent velocity correction and amplitude recovery.

Among these, the step S60 specifically includes: aligning the waveforms of the newly emitted seismic wave with the newly received reflection wave using correlation analysis or least squares or other methods to eliminate time offsets caused by the movement of the seafloor crawler; calculating the propagation time and velocity of the new seismic wave in the water layer, sediment layer, and other media according to the waveform alignment results. This step allows for the obtaining of accurate formation velocity information, providing necessary parameters for subsequent normal moveout correction.

Among these, the step S70 specifically includes: subjecting the new reflection wave to normal moveout correction using preset velocity correction equations, including the P wave velocity correction equation, the S wave velocity correction equation, the multiple correction equation, the NMO correction equation, and the DMO correction equation according to the velocity information in each medium calculated in step S60, eliminating time differences caused by formation anisotropy, multiple reflections, and other factors. This step allows for maintaining the time axis of the reflection wave signal spatially consistent, providing good basic data for subsequent spectrum analysis and amplitude recovery.

Among these, the step S80 specifically includes: subjecting the corrected reflection wave signal to a Fourier transform to obtain spectrum information; eliminating amplitude attenuation caused by formation absorption, divergence and other factors and improving the signal-to-noise ratios of reflection waves using geometric divergence correction, absorption compensation and other amplitude recovery methods; obtaining high-quality seismic detection data by combining the results of spectrum analysis and amplitude recovery, providing support for subsequent geological interpretation. This step can improve the resolution and reliability of signals, providing valuable detection data for the final geological interpretation.

Compared with existing technologies, the beneficial effects of the seismic detection system based on a seafloor crawler provided by the present invention are as follows:

Firstly, the present invention uses a controllable seismic source, such as a transducer seismic source or an airgun seismic source, which can emit seismic waves with adjustable frequency, amplitude and duration, and cooperates with the control chip to achieve dynamic optimization of seismic source parameters. Compared with conventional fixed seismic sources, this controllable seismic source can intelligently adjust transmission parameters based on real-time acquired seafloor environmental information, such as formation depth, temperature, density, etc., so that seismic wave attributes are more in line with local geological conditions, thus greatly improving detection accuracy.

Secondly, the present invention integrates multiple advanced algorithms in the data processing phase, including Bayesian outlier detection, attribute-parameter equation modeling, and velocity correction equation, etc. By these algorithms, it is possible to comprehensively analyze the amplitude, frequency, phase and other attributes of seismic reflection waves, intelligently identifying characteristic points that may reflect geological anomalies. Based on these key attributes, a mathematical model describing the propagation of seismic waves is established, enabling precise optimization of source parameters, propagation velocity and other key factors. Finally, with regard to complex seafloor environments, multiple velocity correction methods are employed to effectively eliminate time offsets caused by formation anisotropy, multiple reflections and the like, significantly improving data reliability.

Compared to existing seafloor seismic exploration technologies, the present invention has the following significant advantages: 1) It possesses intelligent sensing and adaptive optimization capabilities, which can dynamically adjust seismic source parameters and data processing strategies based on real-time seafloor environmental information, significantly improving detection accuracy. 2) It utilizes advanced data processing algorithms, which can comprehensively analyze seismic reflection wave attributes, uncover hidden geological information, and provide more reliable basic data for interpretation. 3) It utilizes hardware equipment such as controllable seismic sources and tracked crawlers or multi-legged seafloor crawlers to acquire more comprehensive and accurate seismic data in complex seafloor environments.

In summary, the present invention addresses the technical problems of low comprehensiveness and accuracy associated with existing seafloor seismic exploration methods.

### BRIEF DESCRIPTION OF THE DRAWINGS

FIG. 1 is a schematic diagram of the composition of a seismic detection system based on a seafloor crawler provided by the present invention;

FIG. 2 is a flowchart of the execution steps of a seismic detection control module;

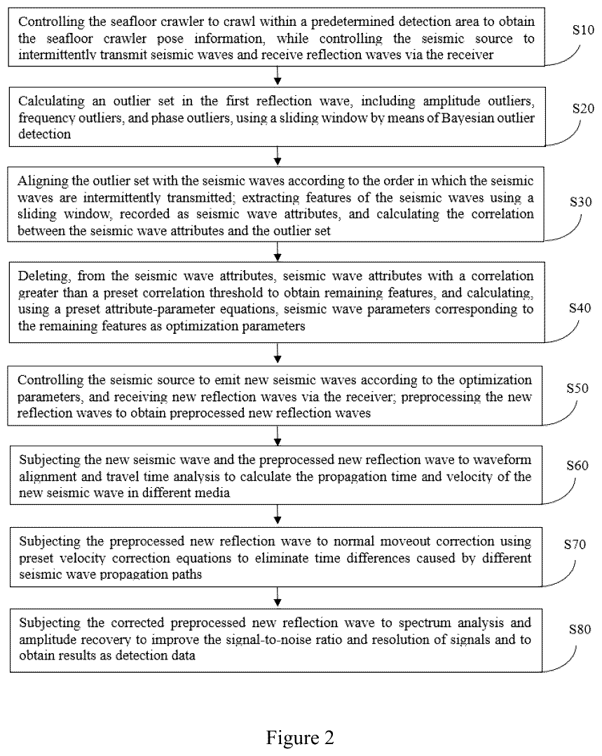

FIG. 3 is a schematic diagram of a wired system of Example 2 of the present invention;

FIG. 4 is a schematic diagram of a wireless system of Example 2 of the present invention.

### DETAILED DESCRIPTION OF THE EMBODIMENTS

To make the objects, technical solutions and advantages of the embodiments of the present invention clearer, the technical solutions in the embodiments of the present invention will be clearly and completely described below with reference to the accompanying drawings in the embodiments of the present invention.

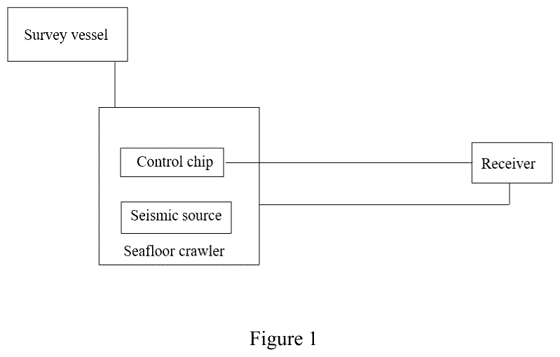

As shown in FIG. 1, it is a schematic diagram of the composition of a seismic detection system based on a seafloor crawler provided by the present invention; the method comprises the following steps: wherein, comprising: a survey vessel, a seafloor crawler, a seismic source, a receiver, and a control chip, wherein the survey vessel and the seafloor crawler are connected by a towing rope; the seafloor crawler has a towing cable provided at the rear; the seismic source and the receiver are mounted on the towing cable; the seafloor crawler is provided with an electronic cabin; the data control chip is disposed within the electronic cabin; the control chip exchanges data with the drive unit of the seafloor crawler, the seismic source, and the receiver; the control chip is provided with a seismic exploration control module for setting the vibration parameters of the seismic source and preprocessing the data collected by the receiver to ultimately obtain seismic exploration data; the electronic cabin also contains a data transmission device, which is electrically connected to the control chip and is used to transmit the seismic exploration data to the survey vessel.

The seismic detection control module is used to perform the following steps:
S10, controlling the seafloor crawler to crawl within a predetermined detection area to obtain the seafloor crawler pose information, while controlling the seismic source to intermittently transmit seismic waves and receive reflection waves via the receiver;
S20, calculating an outlier set in the first reflection wave, including amplitude outliers, frequency outliers, and phase outliers, using a sliding window by means of Bayesian outlier detection;
S30, aligning the outlier set with the seismic waves according to the order in which the seismic waves are intermittently transmitted; extracting attributes of the seismic waves using a sliding window, recorded as seismic wave attributes, and calculating the correlation between the seismic wave attributes and the outlier set;
S40, deleting, from the seismic wave attributes, seismic wave attributes with a correlation greater than a preset correlation threshold to obtain remaining features, and calculating, using a preset attribute-parameter equations, seismic wave parameters corresponding to the remaining features as optimization parameters;
S50, controlling the seismic source to emit new seismic waves according to the optimization parameters, and receiving new reflection waves via the receiver; preprocessing the new reflection waves to obtain preprocessed new reflection waves;
S60, subjecting the new seismic wave and the preprocessed new reflection wave to waveform alignment and travel time analysis to calculate the propagation time and velocity of the new seismic wave in different media;
S70, subjecting the preprocessed new reflection wave to normal moveout correction using preset velocity correction equations to eliminate time differences caused by different seismic wave propagation paths;
S80, subjecting the corrected preprocessed new reflection wave to spectrum analysis and amplitude recovery to improve the signal-to-noise ratio and resolution of signals and to obtain results as detection data.

Below is a detailed description of the specific implementation of the above steps:

S10, controlling the seafloor crawler to crawl within a predetermined detection area to obtain the seafloor crawler pose information, while controlling the seismic source to intermittently transmit seismic waves and receive reflection waves via the receiver. Firstly, sensor modules such as the depth gauge, altimeter, gyroscope, and accelerometer on the seafloor crawler are used to obtain real-time position information of the seafloor crawler within the detection area, including depth, altitude, heading angle, and pitch angle. At the same time, the control chip is used to control the seismic source to transmit intermittent seismic waves. After each transmission, the reflected seismic wave signal is recorded by the receiver array. The purpose of this step is to obtain seafloor topography information and raw seismic reflected wave data, providing the basis for subsequent signal processing and geological interpretation.

Step S20, calculating an outlier set in the first reflection wave, including amplitude outliers, frequency outliers, and phase outliers, using a sliding window by means of Bayesian outlier detection. Firstly, the received seismic reflection wave signal is divided into multiple short time windows, and the amplitude, frequency, and phase attributes within each time window are statistically analyzed. Then, using the Bayesian anomaly detection method, the probability of outlier for each attribute under the given observation data is calculated. Specifically, for amplitude attributes, an amplitude outlier is identified when the amplitude exceeds the mean value within the sliding window plus or minus 2-3 times the standard deviation. For frequency attributes, a frequency outlier is identified when the frequency exceeds the mean within the sliding window plus or minus 2-3 times the standard deviation. For phase attributes, a phase outlier is identified when the phase exceeds the mean within the sliding window plus or minus 2-3 times the standard deviation. The purpose of this step is to automatically identify characteristic points in the original reflected wave that may reflect geological anomalies, providing clues for subsequent processing and analysis.

Step S30, aligning the outlier set with the seismic waves according to the order in which the seismic waves are intermittently transmitted; extracting attributes of the seismic waves using a sliding window, recorded as seismic wave attributes, and calculating the correlation between the seismic wave attributes and the outlier set. Firstly, based on the emission timing of the seismic source, each outlier is aligned and paired with the corresponding seismic wave reflection signal. Then, the attributes of each seismic wave reflection signal, such as amplitude, frequency, and phase, are extracted and statistically analyzed using a sliding window method, and recorded as seismic wave attributes. Finally, the relevancy, i.e., correlation, between the seismic wave attributes and the outlier set is calculated. The higher the correlation, the more strongly the seismic wave attribute correlates with the outlier. The purpose of this step is to deeply explore the intrinsic relationship between seismic wave attributes and outliers, providing the basis for subsequent optimization parameter calculations.

Step S40, deleting, from the seismic wave attributes, seismic wave attributes with a correlation greater than a preset correlation threshold to obtain remaining features, and calculating, using a preset attribute-parameter equations, seismic wave parameters corresponding to the remaining features as optimization parameters. Firstly, a reasonable correlation threshold is set, such as 0.7. Seismic wave attributes with correlations greater than the threshold are removed from the attribute set to obtain remaining attributes. Then, seismic source parameters corresponding to the remaining attributes, such as frequency, amplitude, and duration, are calculated and used as optimization parameters using preset attribute-parameter equations, including frequency, amplitude, and duration equations. The purpose of this step is to the attributes most relevant to outliers from a large number of seismic wave attributes, and based on these, the optimal seismic source parameters can be calculated, providing the basis for subsequent seismic source optimization.

Step S50: controlling the seismic source to emit new seismic waves according to the optimization parameters, and receiving new reflection waves via the receiver; preprocessing the new reflection waves to obtain preprocessed new reflection waves. Firstly, the control chip controls the seismic source to emit new seismic waves using the optimization parameters calculated in step S40. The receiver records the new seismic wave reflection signals and then preprocesses these new reflections, including denoising, frequency band filtering, and waveform correction, to obtain preprocessed new reflection wave data. The purpose of this step is to obtain new seismic reflection data of higher quality using the optimized seismic source parameters, providing the basis for subsequent velocity correction and amplitude recovery.

Step S60, subjecting the new seismic wave and the preprocessed new reflection wave to waveform alignment and travel time analysis to calculate the propagation time and velocity of the new seismic wave in different media. Firstly, the waveforms of the newly emitted seismic wave are aligned with the newly received reflection wave using correlation analysis or least squares or other methods to eliminate time offsets caused by the movement of the seafloor crawler. Then, the propagation time and velocity of the new seismic wave in the water layer, sediment layer, and other media are calculated according to the waveform alignment results. The purpose of this step is to obtain accurate formation velocity information, providing necessary parameters for subsequent normal moveout correction.

Step S70, subjecting the preprocessed new reflection wave to normal moveout correction using preset velocity correction equations to eliminate time differences caused by different seismic wave propagation paths. The preset velocity correction equations include the P wave velocity correction equation, the S wave velocity correction equation, the multiple correction equation, the NMO correction equation, and the DMO correction equation. The new reflection wave is subjected to normal moveout correction using these equations according to the velocity information in each medium calculated in step S60, eliminating time differences caused by formation anisotropy, multiple reflections, and other factors. The purpose of this step is to maintain the time axis of the reflection wave signal spatially consistent, providing good basic data for subsequent spectrum analysis and amplitude recovery.

Step S80, subjecting the corrected preprocessed new reflection wave to spectrum analysis and amplitude recovery to improve the signal-to-noise ratio and resolution of signals and to obtain results as detection data. Firstly, the corrected reflection wave signal is subjected to a Fourier transform to obtain spectrum information. Then, suitable amplitude recovery methods such as geometric divergence correction and absorption compensation are used to eliminate amplitude attenuation caused by factors such as formation absorption and divergence, thereby improving the signal-to-noise ratios of the reflection waves. Finally, the results of spectrum analysis and amplitude recovery are combined to obtain high-quality seismic data, providing support for subsequent geological interpretation.

Specifically, the principle of the present invention is to construct an intelligent seismic exploration system based on a seafloor crawler. The system primarily comprises a survey vessel, a seafloor crawler, a seismic source, a receiver, and a control chip. Among these, the survey vessel and the seafloor crawler are connected by a towing rope, providing it with power and data transmission support. The seafloor crawler is responsible for maneuvering flexibly in complex seafloor terrain, carrying detection equipment such as the seismic source and receiver, and acquiring comprehensive seismic data. The control chip coordinates the operations of the components, fulfilling the functions of environmental perception, parameter optimization, and data processing.

The entire exploration process can be summarized as follows: Firstly, the seafloor crawler autonomously moves within the designated area, using sensors such as a depth gauge, altimeter, and gyroscope to obtain real-time position information, providing the basis for subsequent data positioning and correction. At the same time, the control chip controls the seismic source to emit intermittent seismic waves, and the receiver records the reflected signals.

Next, the received reflection wave signals are analyzed and processed. Firstly, by using the Bayesian outliner detection method, outlier in amplitude, frequency, and phase within the reflection waves are automatically identified. These outliers may reflect changes in the subsurface geological structure. Then, according to the emission timing of the seismic source, the outliers are paired with the corresponding seismic reflection signals, and the amplitude, frequency, and phase attributes of each reflection signal are statistically analyzed. By calculating the correlation between the attributes and the outliers, the key attributes most relevant to the outliers can be screened.

Based on these key attributes, the present invention establishes a set of attribute-parameter equations, including a frequency equation, an amplitude equation, and a duration equation, to describe the variations of the respective parameters during seismic wave propagation. These equations take into account factors such as formation depth, temperature, and density, and can relatively accurately predict the seismic wave attributes corresponding to the seismic source parameters. The control chip uses these equations to optimize parameters such as the frequency, amplitude, and duration of the seismic source, making the seismic wave attributes more consistent with the current seafloor geological environment.

At the same time, the present invention also establishes a set of velocity correction equations, including P wave velocity correction, S wave velocity correction, multiple correction, NMO correction, and DMO correction, to eliminate time offsets caused by formation anisotropy, multiple reflections, and other factors. Based on the velocity information obtained above in each medium, the control chip uses these equations to dynamically correct the reflection wave signal, ensuring time axis consistency and significantly improving data reliability.

Finally, the corrected reflection wave signal is subjected to spectrum analysis and amplitude recovery to further improve the signal-to-noise ratios and resolution of the signals, obtaining final, high-quality detection data.

To better understand and implement the present invention, a specific example, Example 1, is provided below to demonstrate the seismic detection control module of the present invention. The steps of Example 1 are described in detail as follows:

In step S10, the seafloor crawler is controlled to crawl within a predetermined detection area to obtain the seafloor crawler pose information, while the seismic source is controlled to intermittently transmit seismic waves and receive reflection waves via the receiver. Firstly, sensor modules such as the depth gauge, altimeter, gyroscope, and accelerometer on the seafloor crawler are used to obtain real-time position information of the seafloor crawler within the detection area. Among these, the depth information can be directly measured by the depth meter, recorded as d; the altitude information can be measured by the altimeter, recorded as h; the heading angle θ and the pitch angle ψ can be obtained by gyroscope measurement; and the accelerometer can provide the acceleration information a of the crawler.

At the same time, the control chip is used to control the seismic source to transmit intermittent seismic waves. After each transmission, the reflected seismic wave signal is recorded by the receiver array. The purpose of this step is to obtain seafloor topography information and raw seismic reflected wave data, providing the basis for subsequent signal processing and geological interpretation.

In step S20, an outlier set in the first reflection wave, including amplitude outliers, frequency outliers, and phase outliers, is calculated using a sliding window by means of Bayesian outlier detection. Firstly, the received seismic reflection wave signal is divided into multiple short time windows, and the amplitude, frequency, and phase attributes within each time window are statistically analyzed. The amplitude in the i th time window is recorded as Aᵢ, the frequency as fᵢ, the phase as φᵢ.

Then, using the Bayesian anomaly detection method, the probability of outlier for each attribute under the given observation data is calculated. The principle of Bayesian outlier detection is as follows:

$$P ( A \vert D ) = \frac{P ( D \vert A ) \cdot P ( A )}{P ( D )}$$

wherein P(A|D) is posterior probability of outlier occurrence given the observed data D; P(D|A) is likelihood probability of the observed data under abnormal conditions; P(A) is prior probability of outlier occurrence; P(D) is marginal probability of the observed data.

For amplitude attributes, when |Aᵢ−μ_{A}|>k_{A}·σ_{A}, it is determined as an amplitude outlier; wherein μ_{A} and σ_{A} are the mean and standard deviation of amplitudes within the sliding window, respectively, and k_{A} is the amplitude outlier determination coefficient, which typically is 2˜3.

For frequency attributes, when |fᵢ−μ_{f}|>k_{f}·σ_{f}, it is determined as a frequency outlier; wherein μ_{f} and σ_{f} are the mean and standard deviation of dominant frequencies within the sliding window, respectively, and k_{f} is the frequency outlier determination coefficient, which typically is 2˜3.

wherein μ_{φ} and σ_{φ} are the mean and standard deviation of instantaneous phases within the sliding window, respectively, and k_{φ} is the phase outlier determination coefficient, which typically is 2˜3.

The purpose of this step is to automatically identify characteristic points in the original reflected wave that may reflect geological anomalies, providing clues for subsequent processing and analysis.

In step S30, the outlier set is aligned with the seismic waves according to the order in which the seismic waves are intermittently transmitted; attributes of the seismic waves are extracted using a sliding window, recorded as seismic wave attributes, and the correlation between the seismic wave attributes and the outlier set is calculated.

Firstly, based on the emission timing of the seismic source, i.e., the t th emitted seismic wave corresponds to the t th reflection wave, each outlier is aligned and paired with the corresponding seismic wave reflection signal. Then, the attributes of each seismic wave reflection signal are extracted and statistically analyzed. The amplitude attributes of the t th seismic wave reflection signal are denoted as Aₜ, the frequency attributes as fₜ, and the phase attributes as φₜ. Using a sliding window method, the mean and standard deviation of these attributes can be calculated, denoted as μ_{A}_{ₜ}, σ_{A}_{ₜ}; μ_{f}_{ₜ}, σ_{f}_{ₜ}; μ_{φ}_{ₜ}, σ_{φ}_{ₜ}.

Finally, the correlation between the seismic wave attributes and the outlier set is calculated. Correlation r can be defined as:

$$r = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2}} \sqrt{{\sum }_{i = 1}^{n} {( {y}_{i} - \overline{y} )}^{2}}}$$

wherein xᵢ are seismic wave attributes, yᵢ are outlier sets, x̅ and y̅ are the means thereof, respectively. The higher the correlation, the more strongly the seismic wave attribute correlates with the outlier.

The purpose of this step is to deeply explore the intrinsic relationship between seismic wave attributes and outliers, providing the basis for subsequent optimization parameter calculations.

In step S40, from the seismic wave attributes, seismic wave attributes with a correlation greater than a preset correlation threshold are deleted to obtain remaining features, and using a preset attribute-parameter equations, seismic wave parameters corresponding to the remaining features are calculated as optimization parameters.

Firstly, a reasonable correlation threshold is set, such as 0.7. Seismic wave attributes with correlations greater than the threshold are removed from the attribute set to obtain remaining attributes {Aᵢ, fᵢ, φᵢ}.

Then, the preset attribute-parameter equations are used to model the remaining attributes and obtain the optimization values of the seismic source parameters. These attribute-parameter equations include:

### Frequency Equation:

$$f = {f}_{0} + α \cdot log ( d ) + β \cdot T + γ \cdot ρ + {ε}_{f}$$

wherein f₀ is initial frequency; d is detection depth; T is seafloor temperature; ρ is seafloor sediment density; α, β, γ are undetermined coefficients; ε_{f} is error term.

### Amplitude Equation:

$$A = {A}_{0} \cdot {e}^{- λ d} \cdot ( 1 + μ \cdot v + v \cdot a ) + {ε}_{A}$$

wherein A₀ is initial amplitude; λ, μ, ν are undetermined coefficients; v is seafloor crawler velocity; a is seafloor crawler acceleration; ε_{A} is error term.

### Duration Equation:

$$t = {t}_{0} + ω \cdot sin ( θ ) + ϕ \cdot cos ( ψ ) + χ \cdot H + {ε}_{t}$$

wherein t₀ is initial duration, θ is seafloor slope, ψ is the pitch angle of the seafloor crawler, H is seawater depth, ω, φ, χ are undetermined coefficients, εₜ is error term.

The purpose of this step is to the attributes most relevant to outliers from a large number of seismic wave attributes, and based on these, the optimal seismic source parameters can be calculated, providing the basis for subsequent seismic source optimization.

In step S50, the seismic source is controlled to emit new seismic waves according to the optimization parameters, and new reflection waves are received via the receiver; and the new reflection waves are preprocessed to obtain preprocessed new reflection waves.

Firstly, the control chip controls the seismic source to emit new seismic waves using the optimization parameters, f, A, t, calculated in step S40. The receiver records the new seismic wave reflection signals and then preprocesses these new reflections, including denoising, frequency band filtering, and waveform correction, to obtain preprocessed new reflection wave data.

The purpose of this step is to obtain new seismic reflection data of higher quality using the optimized seismic source parameters, providing the basis for subsequent velocity correction and amplitude recovery.

In step S60, the new seismic wave and the preprocessed new reflection wave are subjected to waveform alignment and travel time analysis to calculate the propagation time and velocity of the new seismic wave in different media.

Firstly, the waveforms of the newly emitted seismic wave x(t) are aligned with the newly received reflection wave y(t) using correlation analysis or least squares or other methods to eliminate time offsets caused by the movement of the seafloor crawler. The objective function for waveform alignment is:

$$J = \int {[ x ( t ) - α y ( t - τ ) ]}^{2} d t ;$$

wherein α are amplitude adjustment coefficients, and τ are the time offsets. Solving the equation, α,τ that minimizes J completes waveform alignment.

Then, the propagation time and velocity of the new seismic wave in the water layer, sediment layer, and other media are calculated according to the waveform alignment results. For the i th layer of media, its propagation time Tᵢ and velocity Vᵢ satisfy:

$${T}_{i} = \frac{{d}_{i}}{{V}_{i}} ;$$

wherein dᵢ is the thickness of the i th layer of media.

The purpose of this step is to obtain accurate formation velocity information, providing necessary parameters for subsequent normal moveout correction.

In step S70, the preprocessed new reflection wave is subjected to normal moveout correction using preset velocity correction equations to eliminate time differences caused by different seismic wave propagation paths.

The preset velocity correction equations include:

### P-Wave Velocity Correction Equation:

$${V}_{p} = {V}_{p 0} + {k}_{p} \cdot P + {m}_{p} \cdot S + {n}_{p} \cdot \frac{\partial P}{\partial d} + {ε}_{p} ;$$

wherein Vₚ₀ is initial P wave velocity; P is pore pressure; S is rock saturation;

$$\frac{\partial P}{\partial d}$$

is pressure gradient; kₚ, mₚ, nₚ are undetermined coefficients; εₚ is error term.

### S Wave Velocity Correction Equation:

$${V}_{s} = {V}_{s 0} + {k}_{s} \cdot σ + {m}_{s} \cdot ϕ + {n}_{s} \cdot \sqrt{f} + {ε}_{s} ;$$

wherein Vₛ₀ is initial S wave velocity; σ is effective stress; φ is porosity; f is dominant frequency; kₛ, mₛ, nₛ are undetermined coefficients; εₛ is error term.

### Multiple Wave Correction Equation:

$${T}_{m} = {T}_{p} + \frac{2 h}{{V}_{w}} \cdot {( 1 + \frac{{V}_{w}}{{V}_{p}} \cdot {sin}^{2} ( {θ}_{i} ) )}^{1 / 2} + {ε}_{m} ;$$

wherein Tₘ is travel time after multiple correction; Tₚ is original P wave travel time; h is water depth; V_{w} is sound velocity in water; Vₚ is formation P wave velocity; θᵢ is incidence angle; εₘ is error term.

### NMO Correction Equation:

$${T}_{NMO} = \sqrt{{T}_{0}^{2} + \frac{{x}^{2}}{{V}_{RMS}^{2}}} - {T}_{0} + {ε}_{N} ;$$

wherein T_{MON} is NMO correction time; T₀ is zero-offset travel time; x is offset; V_{RMS} is root mean square velocity; ε_{N} is error term.

### DMO Correction Equation:

$${T}_{DMO} = {T}_{NMO} - \frac{{x}^{2} \cdot {tan}^{2} ( θ )}{2 \cdot {V}_{int}^{2} \cdot {T}_{0}} + {ε}_{D} ;$$

wherein T_{DMO} is DMO correction time; θ is reflection point dip angle; Vᵢₙₜ is interlayer velocity; ε_{D} is error term.

The new reflection wave is subjected to normal moveout correction using these equations according to the velocity information, Vₚ, Vₛ, V_{w}, in each medium calculated in step S60, eliminating time differences caused by formation anisotropy, multiple reflections, and other factors.

The purpose of this step is to maintain the time axis of the reflection wave signal spatially consistent, providing good basic data for subsequent spectrum analysis and amplitude recovery.

In step S80, the corrected preprocessed new reflection wave is subjected to spectrum analysis and amplitude recovery to improve the signal-to-noise ratio and resolution of signals and to obtain results as detection data.

Firstly, the corrected reflection wave signal x(t) is subjected to a Fourier transform to obtain spectrum X(f):

$$X ( f ) = \int x ( t ) {e}^{- j 2 π ft} dt ;$$

Then, suitable amplitude recovery methods such as geometric divergence correction and absorption compensation are used to eliminate amplitude attenuation caused by factors such as formation absorption and divergence. Geometric divergence correction can use the following equation:

$${A}_{c} = A \cdot \sqrt{\frac{{d}_{0}}{d}} ;$$

wherein A_{c} are corrected amplitudes, A are original amplitudes, d₀ are reference distances, and, d are actual distances. Absorption compensation can use:

$${A}_{a} = A \cdot {e}^{α d} ;$$

wherein α are attenuation coefficients, which can be measured experimentally or estimated using empirical formulas.

Finally, the results of spectrum analysis and amplitude recovery are combined to obtain high-quality seismic data, providing support for subsequent geological interpretation.

To better understand and implement the present invention, a specific example, Example 2, is provided below.

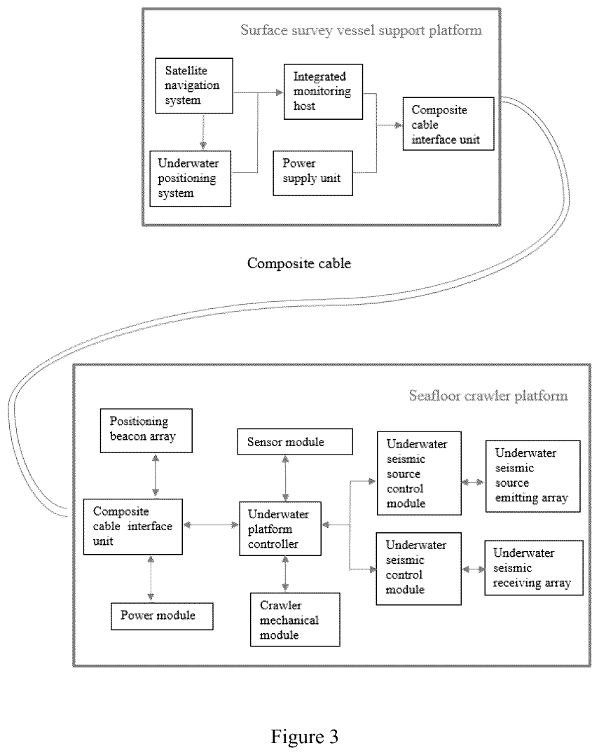

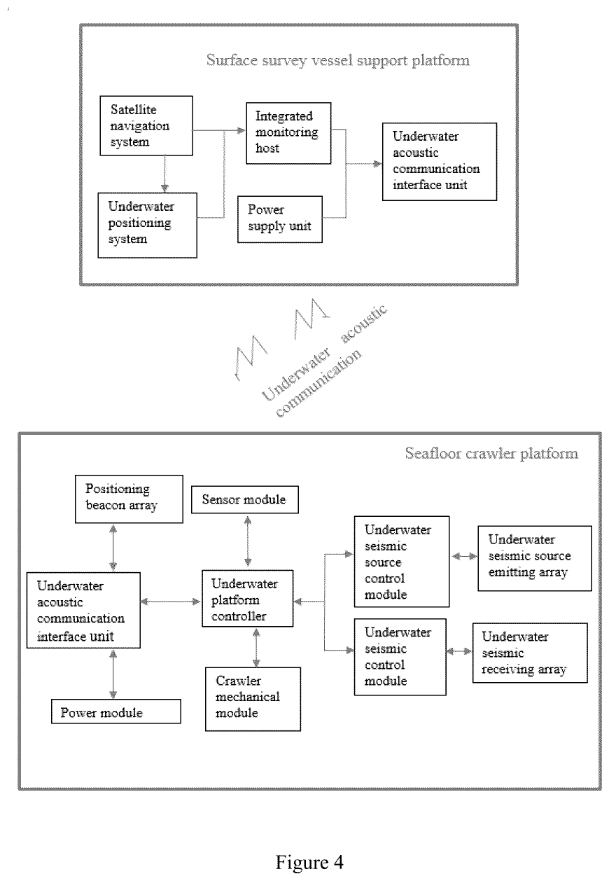

As shown in FIGS. 3-4, Example 2 proposes a seismic exploration system based on a seafloor crawler, the system primarily consisting of a survey vessel, a seafloor crawler, a seismic source, a receiver, and a control chip. The overall structure and operating principle of the system are as follows:

### 1. Overall System Structure

### 1.1 Survey Vessel

The survey vessel is the command center and data processing center for the entire exploration system. The survey vessel is equipped with the following equipment:

a) Satellite navigation system, for locating the position of the survey vessel in real time, with centimeter-level accuracy.

b) Underwater positioning system, for locating the position of the seafloor crawler, typically using an ultra-short baseline (USBL) positioning system.

c) Power supply unit, for providing a stable power supply for the entire system, including the power required by the seafloor crawler.

d) Data processing center, equipped with a high-performance computer for receiving, storing, and processing seismic data transmitted by the seafloor crawler.

### 1.2 Seafloor Crawler

The seafloor crawler is the core component of this system; a tracked seafloor crawler is used, which is capable of moving stably in complex seabed terrain. The seafloor crawler primarily consists of the following components:

a) Drive unit, consisting of a motor and tracks, driving the crawler across the seafloor.

b) Electronic cabin, a sealed cabin housing electronic components such as a control chip and data transmission device.

c) Sensor module, at least including a depth gauge, altimeter, gyroscope, and accelerometer, for obtaining the pose information of the crawler and environmental parameters.

### 1.3 Seismic Source

The seismic source is a controllable seismic source, which can be any one of a controllable transducer seismic source and a controllable airgun seismic source. The seismic source is mounted on the towing cable at the rear of the seafloor crawler; its vibrating surface maintains a good contact with the seafloor sediment to improve the seismic source output efficiency.

### 1.4 Receiver

The receiver can be a node receiver array or a multi-channel seismic cable, mounted on the towing cable at the rear of the seafloor crawler. Preferably, a node receiver array is used, including multiple three-component geophones and multiple hydrophones. The three-component geophones are used to receive vector seismic signals in the X, Y, and Z directions, and the hydrophones are used to receive scalar seismic signals.

### 1.5 Control Chip

The control chip is installed in the electronic cabin of the seafloor crawler and is the “brain” of the entire system. The control chip is mainly responsible for the following functions:

a) Exchange data with the driving unit, seismic source and receiver of the seafloor crawler.

b) Set the vibration parameters of the seismic source.

c) Preprocess the data collected by the receiver to obtain seismic detection data.

d) Send seismic detection data to the survey vessel through data transmission device.

### 2. System Operating Principle

### 2.1 System Deployment

After the survey vessel arrives at the predetermined detection area, it launches the seafloor crawler into the sea. The seafloor crawler is connected to the survey vessel through a towing rope, using a cable connection. The electrical energy required by the crawler is transmitted by the survey vessel through the towing rope, and real-time data transmission is achieved at the same time.

### 2.2 Seismic Detection Process

After the seafloor crawler reaches the seafloor, it starts crawling along the preset path. During the crawling process, the seismic detection control module in the control chip performs the following steps:

S10: controlling the seafloor crawler to crawl within a predetermined detection area to obtain the seafloor crawler pose information, while controlling the seismic source to intermittently transmit seismic waves and receive reflection waves via the receiver.

S20: calculating an outlier set in the first reflection wave, including amplitude outliers, frequency outliers, and phase outliers, using a sliding window by means of Bayesian outlier detection.

The Bayesian outlier detection method is specifically described as follows:

$$P ( A \vert D ) = \frac{P ( D \vert A ) \cdot P ( A )}{P ( D )} ;$$

wherein P(A|D) is posterior probability of outlier occurrence given the observed data D; P(D|A) is likelihood probability of the observed data under, abnormal conditions; P(A) is prior probability of outlier occurrence; P(D) is marginal probability of the observed data.

Criteria for determining outliers are as follows:

### 1) Amplitude Outlier:

$$\vert {A}_{i} - {μ}_{A} \vert > {k}_{A} \cdot {σ}_{A} ;$$

### 2) Frequency Outlier:

$$\vert {f}_{i} - {μ}_{f} \vert > {k}_{f} \cdot {σ}_{f} ;$$

### 3) Phase Outlier:

$$\vert {ϕ}_{i} - {μ}_{ϕ} \vert > {k}_{ϕ} \cdot {σ}_{ϕ} ;$$

wherein Aᵢ, fᵢ, φᵢ are respectively the amplitude, dominant frequency and instantaneous phase of the i th sampling point; μ and σ are respectively the mean and standard deviation of corresponding parameters; k are outlier determination coefficients.

S30: aligning the outlier set with the seismic waves according to the order in which the seismic waves are intermittently transmitted. The attributes of the seismic waves are extracted using a sliding window, recorded as seismic wave attributes, and the correlation between the seismic wave attributes and the outlier set is calculated.

S40: deleting, from the seismic wave attributes, seismic wave attributes with a correlation greater than a preset correlation threshold to obtain remaining features, and calculating, using a preset attribute-parameter equations, seismic wave parameters corresponding to the remaining features as optimization parameters.

The preset attribute-parameter equations include:

### 1) Frequency Equation:

$$f = {f}_{0} + α \cdot log ( d ) + β \cdot T + γ \cdot ρ + {ε}_{f} ;$$

### 2) Amplitude Equation:

$$A = {A}_{0} \cdot {e}^{- λ d} \cdot ( 1 + μ \cdot v + v \cdot a ) + {ε}_{A} ;$$

### 3) Duration Equation:

$$t = {t}_{0} + ω \cdot sin ( θ ) + ϕ \cdot cos ( ψ ) + χ \cdot H + {ε}_{t} ;$$

S50: controlling the seismic source to emit new seismic waves according to the optimization parameters, and receiving new reflection waves via the receiver. The new reflection waves are preprocessed to obtain preprocessed new reflection waves.

S60: subjecting the new seismic wave and the preprocessed new reflection wave to waveform alignment and travel time analysis to calculate the propagation time and velocity of the new seismic wave in different media;

S70: subjecting the preprocessed new reflection wave to normal moveout correction using preset velocity correction equations to eliminate time differences caused by different seismic wave propagation paths.

The velocity correction equations include:

### 1) P-Wave Velocity Correction Equation:

$${V}_{p} = {V}_{p 0} + {k}_{p} \cdot P + {m}_{p} \cdot S + {n}_{p} \cdot \frac{\partial P}{\partial d} + {ε}_{p} ;$$

### 2) S Wave Velocity Correction Equation:

$${V}_{s} = {V}_{s 0} + {k}_{s} \cdot σ + {m}_{s} \cdot ϕ + {n}_{s} \cdot \sqrt{f} + {ε}_{s} ;$$

### 3) Multiple Correction Equation:

$${T}_{m} = {T}_{p} + \frac{2 h}{{V}_{w}} \cdot {( 1 + \frac{{V}_{w}}{{V}_{p}} \cdot {sin}^{2} ( {θ}_{i} ) )}^{1 / 2} + {ε}_{m} ;$$

### 4) NMO Correction Equation:

$${T}_{N M O} = \sqrt{{T}_{0}^{2} + \frac{{x}^{2}}{{V}_{R M S}^{2}}} - {T}_{0} + {ε}_{N} ;$$

### 5) DMO Correction Equation:

$${T}_{D M O} = {T}_{N M O} - \frac{{x}^{2} \cdot {tan}^{2} ( θ )}{2 \cdot {V}_{i n t}^{2} \cdot {T}_{0}} + {ε}_{D} ;$$

S80: subjecting the corrected preprocessed new reflection wave to spectrum analysis and amplitude recovery to improve the signal-to-noise ratio and resolution of signals and to obtain results as detection data.

### 2.3 Data Transmission

The control chip transmits the processed seismic detection data to the survey vessel via a data transmission device. Data transmission can be performed via a data cable or a wireless channel. In this example, a cable connection is used, with data transmitted at high speed via the optical fiber in the towing rope.

### 2.4 Data Processing and Interpretation

After receiving the seismic data, the data processing center on the survey vessel performs further processing and interpretation, including but not limited to the following:

a) Data quality control: denoising, static error correction, etc. are performed.

b) Velocity analysis: performing detailed velocity analysis to establish an accurate velocity model.

c) Pre-stack time migration: migrating data in the time domain using the velocity model.

d) Post-stack processing: including multiple wave removal, frequency band filtering, and amplitude balancing, etc.

e) Geological interpretation: performing geological interpretation tasks such as stratigraphic delineation, fault identification, reservoir prediction, etc. based on the processed seismic profiles.

### 3. System Advantages

### 3.1 High-Precision Seismic Detection

By using a seafloor crawler to tow the seismic source and receivers ensures close contact of the seismic source and receivers with the seafloor, significantly improving the transmission efficiency of the seismic source energy and the sensitivity of the receivers. At the same time, the stability of the seafloor crawler ensures continuous and consistent data acquisition.

### 3.2 Adaptive Parameter Optimization

The system analyzes outliers in reflection waves in real time and dynamically adjusts seismic source parameters, achieving adaptive optimization of seismic detection parameters. This method automatically adjusts detection strategies based on different geological environments, improving detection efficiency and accuracy.

### 3.3 Real-Time Data Processing and Transmission

The control chip performs real-time preprocessing on received seismic data and transmits it to the survey vessel via a high-speed data link, enabling geologists to obtain timely detection results and adjust detection plans as needed.

### 3.4 Comprehensive Application of Multiple Correction Methods

The system uses a variety of velocity correction equations, including P wave, S wave, multiple wave, NMO and DMO corrections, which fully consider the propagation attributes of seismic waves in complex geological environments and greatly improve the accuracy and resolution of seismic data.

### 4. Key Technical Parameters

### 4.1 Seafloor Crawler

Maximum operating depth: 6000 meters;
Crawling speed: 0-2 meters/seconds;
Endurance: ≥24 hours;
Positioning accuracy: ±0.5 meters;

### 4.2 Seismic Source

Frequency range: 10-2000 Hz;
Maximum output power: 5000 J;
Transmission interval: Adjustable, minimum 0.1 second;

### 4.3 Receiver

Sampling rate: 1-16 kHz, adjustable;
Dynamic range: 140 dB;
Trajectory spacing: 1 m-25 m.

To further better understand and implement the present invention, Example 3, which demonstrates a specific application scenario of the present invention, is provided below: A marine oil and gas institution plans to conduct exploration activities in a certain area of the South China Sea and requires the use of high-precision seafloor seismic exploration technology to obtain accurate geological information to guide subsequent mining operations. The institution decided to implement the intelligent seismic exploration system based on a seafloor crawler proposed in the present invention for a three-month practical application.

### Stage One: System Deployment

Firstly, the institution deployed a 3000-ton specialized survey vessel and installed supporting equipment, including a satellite navigation system, an underwater positioning system, and a power supply unit. At the same time, a tracked seafloor crawler was developed, which is 4 meters long, 2 meters wide, and 1.5 meters high, weighing approximately 5 tons. The crawler houses an electronic cabin for core components such as control chips and data transmission equipment. A 30-meter-long towing cable is attached to at the rear of the crawler, to which the seismic source and receiver array are attached.

The institution selected a controllable airgun seismic source as the seismic wave source. The vibrating surface of the seismic source transmitting array is in direct contact with the seafloor sediment to improve energy coupling efficiency. The receiver utilizes a node-based receiver array, including three-component geophones and hydrophones, totaling 24 wave detection units; the array is 30 meters long and spaced 1.5 meters apart.

The control chip utilizes a high-performance ARM processor and includes functional units such as a seismic detection control module, a velocity correction module, and a data transmission module. This chip enables two-way communication with the seismic source, receivers, and various sensors on the seafloor crawler, enabling intelligent control of the entire exploration operation.

After the hardware was installed and debugged, the survey vessel sailed to the designated exploration area, slowly lowered its mooring anchor, and maintained a relatively stable operating state. The seafloor crawler was connected to the survey vessel via a towing rope, then slowly descended to the seafloor and began autonomously cruising within the designated area.

### Stage Two: Intelligent Exploration

After entering the exploration area, the seafloor crawler first used its onboard sensors, such as a depth gauge, altimeter, and gyroscope, to collect its position information in real time. The control chip transmitted the position data to the survey vessel, establishing the precise three-dimensional coordinate system of the crawler on the seafloor.

The control chip then issued a seismic wave emission command every 10 seconds through the communication interface with the seismic source. According to the command, the seismic source emitted seismic waves toward the seafloor with initial parameters of f=30 Hz, A=5 MPa, t=0.1 s. The receiver array recorded the reflected signals of these seismic waves in real time and transmitted the digitized data to the control chip for preprocessing.

For each set of reflection wave signals, the control chip first used a sliding window method to calculate the statistical attributes of its amplitude, frequency, and phase, including the mean μ_{A}, μ_{f}, μ_{φ} and standard deviation σ_{A}, σ_{f}, σ_{φ}. Then, the outlier occurrence probability of these attributes under the current observation data was evaluated using Bayesian outlier detection:

$$P ( {A}_{i} \vert D ) = \frac{P ( D \vert {A}_{i} ) \cdot P ( {A}_{i} )}{P ( D )} ;$$

wherein Aᵢ represents the amplitude, frequency, or phase attributes, and D represents the current observation data. Empirically, when P(Aᵢ|D)>0.9, the characteristic point is identified as an outlier.

Next, the control chip paired the outliers with the corresponding reflection wave signals based on the emission timing of the seismic source. Then, a sliding window method was used to extract the amplitude A, frequency f, and phase φ attributes of each set of reflection waves, and their correlation coefficients r with the outlier set were calculated:

$$r = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2}} \sqrt{{\sum }_{i = 1}^{n} {( {y}_{i} - \overline{y} )}^{2}}} ;$$

wherein xᵢ are seismic wave attributes, yᵢ are outlier sets, x̅ and y̅ are the means thereof, respectively. The higher the correlation, the more strongly the seismic wave attribute correlates with the outlier.

By the above analysis, the control chip selected key attributes that were highly correlated with the outliers and calculated the corresponding source optimization parameters using preset attribute-parameter equations:

$$Frequency equation : f = 30 + 2.5 \cdot log ( d ) + 1.8 \cdot T + 0.6 \cdot ρ + {ε}_{f} ;$$

$$Amplitude equation : A = 5 \cdot {e}^{- 0.12 d} \cdot ( 1 + 0.35 \cdot v + 0.2 \cdot a ) + {ε}_{A} ;$$

$$Duration equation : t = 0.1 + 0.08 \cdot sin ( θ ) + 0.05 \cdot cos ( ψ ) + 0.02 \cdot H + {ε}_{t} ;$$

wherein d is detection depth; T is seafloor temperature; ρ is seafloor sediment density; v is seafloor crawler velocity; a is seafloor crawler acceleration; θ is seafloor slope; ψ is the pitch angle of the seafloor crawler; H is seawater depth; ε_{f}, ε_{A}, εᵢ are error terms.

Based on these optimized parameters, the control chip issued a new seismic source launch command. The seismic source then adjusted the frequency to 35 Hz, the amplitude to 7 MPa, and the duration to 0.15 s, and again transmitted seismic waves to the seafloor. The receivers recorded the new reflection signal and transmitted it back to the control chip for subsequent processing.

At the same time, the control chip used the method in step S60 to perform waveform alignment and travel time analysis on the new reflection wave signal, calculating the propagation velocity of seismic waves in different media such as water layers and sediment layers. For the water layer, the measured velocity was V_{w}=1500 m/s; for the sediment layer, Vₚ=2800 m/s, Vₛ=1200 m/s.

With this velocity information, the control chip immediately subjected the new reflection wave signal to normal moveout correction using preset velocity correction equations. For example, the P wave velocity correction was:

$${V}_{p} = 2800 + 35 \cdot P + 22 \cdot S + 15 \cdot \frac{\partial P}{\partial d} + {ε}_{p} ;$$

wherein P=15 MPa is pore pressure, S=0.7 is rock saturation,

$$\frac{\partial P}{\partial d} = 0.3$$

MPa/m is pressure gradient. This correction effectively eliminated time offsets caused by factors such as formation anisotropy.

Similarly, the control chip also applied multiple correction, NMO correction, and DMO correction methods to further optimize the time axis of the reflection wave signal. Finally, the corrected signal was subjected to spectrum analysis and amplitude recovery processing to improve the signal-to-noise ratio and resolution, ultimately producing high-quality detection data.

### Stage Three: Data Transmission and Analysis

After completing a set of data acquisition and preprocessing, the control chip transmitted the results to the survey vessel via data cables or wireless channels. The data transmission equipment on the survey ship integrated and stored these data to form a complete seismic detection data set.

The above is only specific embodiments of the present invention, but the scope of protection of the present invention is not limited to this. Any skilled person familiar with this technical field can easily think of changes or substitutions within the technical scope disclosed in the present invention, which should be included in the scope of protection of the present invention.

What is claimed is:

1. A seismic detection system based on a seafloor crawler, comprising: a survey vessel, a seafloor crawler, a seismic source, a receiver, and a control chip, wherein the survey vessel and the seafloor crawler are connected by a towing rope; the seafloor crawler has a towing cable provided at the rear; the seismic source and the receiver are mounted on the towing cable; the seafloor crawler is provided with an electronic cabin; the data control chip is disposed within the electronic cabin; the control chip exchanges data with the drive unit of the seafloor crawler, the seismic source, and the receiver; the control chip is provided with a seismic exploration control module for setting the vibration parameters of the seismic source and preprocessing the data collected by the receiver to ultimately obtain seismic exploration data; the electronic cabin also contains a data transmission device, which is electrically connected to the control chip and is used to transmit the seismic exploration data to the survey vessel; the seismic detection control module is used to perform the following steps:
S10, controlling the seafloor crawler to crawl within a predetermined detection area to obtain the seafloor crawler pose information, while controlling the seismic source to intermittently transmit seismic waves and receive reflection waves via the receiver;
S20, calculating an outlier set in the first reflection wave, including amplitude outliers, frequency outliers, and phase outliers, using a sliding window by means of Bayesian outlier detection;
S30, aligning the outlier set with the seismic waves according to the order in which the seismic waves are intermittently transmitted; extracting features of the seismic waves using a sliding window, recorded as seismic wave attributes, and calculating the correlation between the seismic wave attributes and the outlier set;
S40, deleting, from the seismic wave attributes, seismic wave attributes with a correlation greater than a preset correlation threshold to obtain remaining features, and calculating, using a preset attribute-parameter equations, seismic wave parameters corresponding to the remaining features as optimization parameters;
S50, controlling the seismic source to emit new seismic waves according to the optimization parameters, and receiving new reflection waves via the receiver;
preprocessing the new reflection waves to obtain preprocessed new reflection waves;
S60, subjecting the new seismic wave and the preprocessed new reflection wave to waveform alignment and travel time analysis to calculate the propagation time and velocity of the new seismic wave in different media;
S70, subjecting the preprocessed new reflection wave to normal moveout correction using preset velocity correction equations to eliminate time differences caused by different seismic wave propagation paths;
S80, subjecting the corrected preprocessed new reflection wave to spectrum analysis and amplitude recovery to improve the signal-to-noise ratio and resolution of signals and to obtain results as detection data.

2. The seismic detection system based on a seafloor crawler according to claim 1, wherein the survey ship is equipped with a satellite navigation system, an underwater positioning system, and a power supply unit.

3. The seismic detection system based on a seafloor crawler according to claim 2, wherein the seafloor crawler is a tracked seafloor crawler or a multi-legged seafloor crawler.

4. The seismic detection system based on a seafloor crawler according to claim 3, wherein the seismic source is a controllable seismic source, including any one or a combination of a controllable transducer seismic source, a controllable electromagnetic seismic source, a controllable hydraulic seismic source, and a controllable airgun seismic source.

5. The seismic detection system based on a seafloor crawler according to claim 4, wherein the vibrating surface of the seismic source transmitting array contacts the seafloor sediment.

6. The seismic detection system based on a seafloor crawler according to claim 5, wherein the receiver is a node-type receiver array or a multi-channel seismic cable.

7. The seismic detection system based on a seafloor crawler according to claim 6, wherein the node-type receiver array includes multiple three-component geophones and multiple hydrophones, wherein the three-component geophones are used to receive vector seismic signals in the X, Y, and Z directions, and the hydrophones are used to receive scalar seismic signals.

8. The seismic detection system based on a seafloor crawler according to claim 7, wherein the data transmission device transmits the seismic detection data to the survey vessel via a data cable or wireless channel.

9. The seismic detection system based on a seafloor crawler according to claim 8, wherein the seafloor crawler is also provided with a sensor module comprising at least a depth gauge, an altimeter, a gyroscope, and an accelerometer.
